(19) United States
(12) Patent Application Publication
(10) Pub. No.: US 2014/0123642 A1
(43) Pub. Date: May 8, 2014

(54) TURBO APPARATUS USING WASTE HEAT RECOVERY SYSTEM FOR VEHICLE

(71) Applicant: HYUNDAI MOTOR COMPANY, Seoul (KR)

(72) Inventor: Woo Seok Kim, Bucheon-si (KR)

(73) Assignee: Hyundai Motor Company, Seoul (KR)

(21) Appl. No.: 13/846,064

(22) Filed: Mar. 18, 2013

(30) Foreign Application Priority Data
Nov. 7, 2012 (KR) 10-2012-0125306

(51) Int. Cl. F02B 37/12

(52) U.S. Cl. CPC F02B 37/12
USPC 60/604

(57) ABSTRACT

A turbo apparatus using a waste heat recovery system for a vehicle may include a waste heat recovery unit heating a working fluid by using waste heat of the vehicle, and an expander provided in a turbocharger and fluid-connected to the waste heat recovery unit, wherein the expander generates a rotational force by using the working fluid supplied from the waste heat recovery unit thereto and transmits the rotational force to a turbo shaft.

### CROSS-REFERENCE TO RELATED APPLICATION

The present application claims priority to Korean Patent Application No. 10-2012-0125306, filed on Nov. 7, 2012, the entire contents of which is incorporated herein for all purposes by this reference.

### BACKGROUND OF THE INVENTION

1. Field of the Invention

The present invention relates to a turbo apparatus which uses a waste heat recovery system for a vehicle to supercharge an engine.

2. Description of Related Art

Typical exhaust heat recovery systems which recover exhaust heat of vehicles use energy recovered from exhaust heat contained in exhaust gas of vehicles so as to change the phase of working fluid such as water or ethanol into superheated vapor and recover it to form a type of energy. A method of generating drive force using an expander and a method of generating electricity are examples of methods which are used in the existing recovery process.

A turbocharger of an engine compresses intake air using the expansion energy of exhaust gas and pumps it into a combustion chamber, thus enhancing the intake efficiency of the engine and reducing a pumping loss, thereby increasing the efficiency of the engine and improving the fuel efficiency. The turbocharger is configured such that exhaust gas rotates a turbine and power generated by the rotation of the turbine rotates an impeller to compress intake air.

As such, in the conventional turbocharger, the operation of the turbine and impeller is dependent on the flow of exhaust gas so that it cannot respond immediately when a driver works an acceleration pedal, thus causing turbo lag.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a turbo apparatus using a waste heat recovery system for a vehicle which is configured such that the operation of the turbo apparatus is improved using energy recovered from the waste heat recovery system, thus reducing turbo lag which is caused in the conventional turbo apparatus and enhancing the responsivity and acceleration performance of the turbo apparatus when the vehicle accelerates, and which eventually makes downsizing and downspeeding of the engine possible and ensures sufficient output power, thus markedly improving the fuel efficiency of the vehicle.

In an aspect of the present invention, a turbo apparatus using a waste heat recovery system for a vehicle may include a waste heat recovery unit heating a working fluid by using waste heat of the vehicle, and an expander provided in a turbocharger and fluid-connected to the waste heat recovery unit, wherein the expander generates a rotational force by using the working fluid supplied from the waste heat recovery unit thereto and transmits the rotational force to a turbo shaft.

The turbo apparatus may further include a working fluid switch unit provided to switch a state of the working fluid of the waste heat recovery unit between a state in which the working fluid passes through the expander and a state in which the working fluid bypasses the expander.

The working fluid switch unit may include an inlet valve provided on a path along which the working fluid is transmitted from the waste heat recovery unit to the expander, an outlet valve provided on a path along which the working fluid that may have passed through the expander returns to the waste heat recovery unit, and a bypass pipe connecting the inlet valve to the outlet valve, wherein the working fluid flows from the inlet valve to the outlet valve while bypassing the expander according to operation of the inlet valve and the outlet valve.

The turbo apparatus may further include a one-way clutch provided between the expander and the turbo shaft of the turbocharger so that the rotational force is transmitted only in a direction from the expander to the turbo shaft.

The expander is disposed between a turbine and a compressor of the turbocharger.

In another aspect of the present invention, a turbo apparatus using a waste heat recovery system for a vehicle, comprising a waste heat recovery unit heating a working fluid by using waste heat of the vehicle, a plurality of compressors provided to compress intake air to be supplied to an engine, and an expander fluidly-connected to the waste heat recovery unit to generate rotational force by using the working fluid supplied from the waste heat recovery unit and coupled to at least one of the compressors, wherein the expander operates the at least one of the compressors by using the rotational force.

The expander transmits the rotational force generated by the working fluid of the waste heat recovery unit, to the at least one of the compressors through a rotating shaft connected thereto.

The plurality of compressors is connected in series to each other to compress, in multiple stages, air to be supplied to the engine.

The plurality of compressors is connected in parallel to each other to selectively compress air to be supplied to the engine.

At least a turbine is fluidly-connected to the at least one of the compressors.

At least one of the plurality of compressors is connected to a turbine.

The working fluid switch unit may include an inlet valve provided on a path along which the working fluid is transmitted from the waste heat recovery unit to the expander, an outlet valve provided on a path along which the working fluid that may have passed through the expander returns to the waste heat recovery unit, and a bypass pipe connecting the inlet valve to the outlet valve so that the working fluid flows from the inlet valve to the outlet valve while bypassing the expander according to operation of the inlet valve and the outlet valve.

The turbo apparatus may include a one-way clutch provided between the expander and a turbo shaft of the turbocharger so that the rotational force is transmitted only in a direction from the expander to the turbo shaft.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a turbo apparatus using a waste heat recovery system for a vehicle, according to various exemplary embodiments of the present invention.

FIG. 2 is a diagram showing the construction of the various exemplary embodiments of FIG. 1.

FIG. 3 is a view illustrating a turbo apparatus using a waste heat recovery system for a vehicle, according to various exemplary embodiments of the present invention.

FIG. 4 is a view illustrating a turbo apparatus using a waste heat recovery system for a vehicle, according to various exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

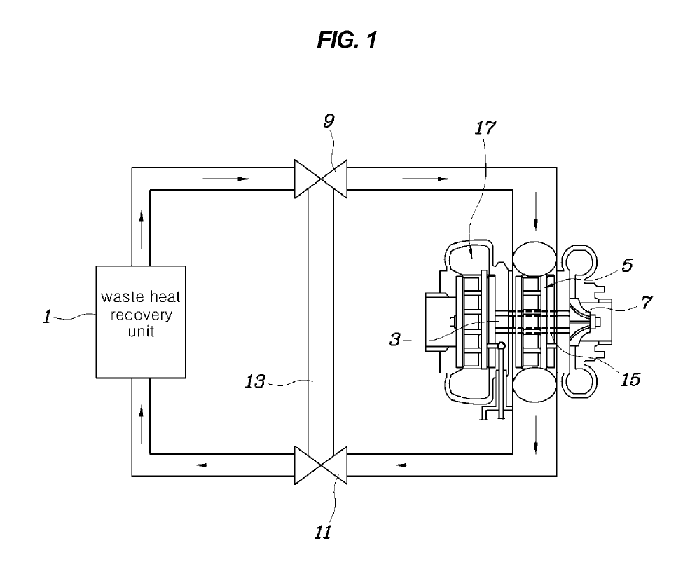

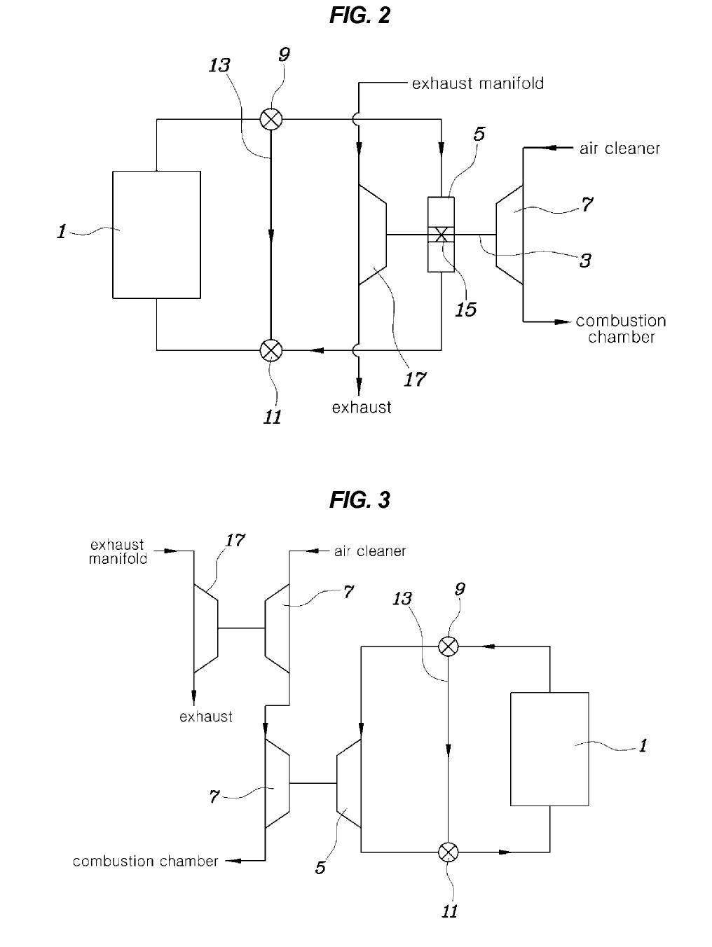

Referring to FIGS. 1 and 2, a turbo apparatus using a waste heat recovery system for a vehicle according to a first embodiment of the present invention includes a waste heat recovery unit 1 which heats working fluid using waste heat of the vehicle, and an expander 5 which is provided in a turbocharger to generate rotational force using working fluid supplied from the waste heat recovery unit 1 and transmit the rotational force to a turbo shaft 3.

The waste heat recovery unit 1 means an apparatus which can recover heat from different kinds of heat sources of the vehicle, for example, not only exhaust gas of the vehicle but also a radiator or an oil cooler, and then use it to heat working fluid.

That is, in the first embodiment, the expander 5 is operated by working fluid that is heated by energy recovered by the waste heat recovery unit 1, thus providing rotational force which can operate the turbo shaft 3 of the turbocharger. The rotational force generated by the expander 5 operates the turbocharger or assists the operation of the turbocharger so that even when the vehicle is in low speed and low load conditions, intake air can be effectively compressed, thus reducing turbo lag of the turbocharger, and enhancing the power output performance. Particularly, in even a downsizing engine or a downspeeding engine, high driving power is ensured, thus preventing the starting performance and acceleration performance of the vehicle from deteriorating.

Therefore, when more powerful or rapid operation of the turbocharger is required, working fluid heated by the waste heat recovery unit 1 passes through the expander 5 and makes the expander 5 transmit rotational force which can operate a compressor 7 of the turbocharger to the turbo shaft 3.

The turbo apparatus according to the first embodiment of the present invention further includes a working fluid switch unit which is provided to switch the state of the working fluid of the waste heat recovery unit 1 between a state in which it passes through the expander 5 and a state in which it bypasses the expander 5.

The working fluid switch unit includes an inlet valve 9, an outlet valve 11 and a bypass pipe 13. The inlet valve 9 is provided on a path along which working fluid is transmitted from the waste heat recovery unit 1 to the expander 5. The outlet valve 11 is provided on a path along which the working fluid that has passed through the expander 5 returns to the waste heat recovery unit 1. The bypass pipe 13 connects the inlet valve 9 to the outlet valve 11 so that working fluid flows from the inlet valve 9 to the outlet valve 11 while bypassing the expander 5.

Therefore, when the waste heat recovery unit 1 has not been able to recover a sufficient amount of heat or the torque of the engine is a negative value vehicle during vehicle coast-down, the inlet valve 9 and the outlet valve 11 are controlled so that the working fluid of the waste heat recovery unit 1 can bypass the expander 5 through the bypass pipe 13 rather than passing through the expander 5.

A one-way clutch 15 is further provided between the expander 5 and the turbo shaft 3 of the turbocharger so that rotational force can be transmitted only in a direction from the expander 5 to the turbo shaft 3.

Therefore, when the working fluid of the waste heat recovery unit 1 bypasses the expander 5 through the bypass pipe 13 and is not able to rotate the expander 5, the expander 5 is prevented from impeding the rotation of the turbo shaft 3, whereby the operation performance of the turbocharger can be maintained in the same level as that of the conventional technique that has no expander.

The expander 5 is disposed between a turbine 17 and the compressor 7 of the turbocharger to make the overall structure more compact. Also, the presence of the expander 5 is advantageous in that the expander 5 spaces the compressor 7 that compresses intake air apart from the turbine 17 through which high-temperature exhaust gas passes, thus preventing the intake air from being undesirably heated.

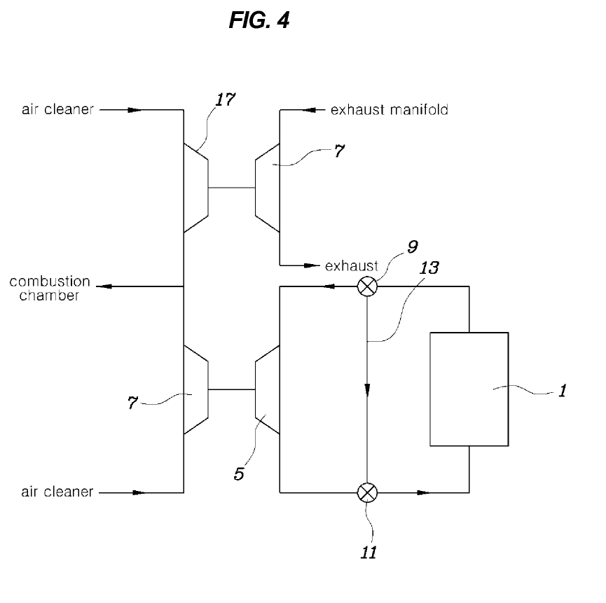

FIGS. 3 and 4 respectively illustrate a second embodiment and a third embodiment of the present invention. A turbo apparatus according to each of the second and third embodiment of the present invention includes a waste heat recovery unit 1 which heats working fluid using waste heat of a vehicle, a plurality of compressors 7 which are provided to compress intake air to be supplied to an engine, and an expander 5 which generates rotational force using working fluid supplied from the waste heat recovery unit 1 and operates at least one of the compressors 7 using the rotational force.

At least one compressor 7 of a supercharging device which is provided with the compressors 7 is configured to be operated by working fluid supplied from the waste heat recovery unit 1. Therefore, compared to the conventional turbo apparatus provided with turbochargers that are operated only by exhaust gas of the engine, the turbo apparatus of the present invention can conduct more various and reliable supercharging functions.

Of course, the expander 5 transmits rotational force generated by the working fluid of the waste heat recovery unit 1 to the compressor 7 through a rotating shaft that is directly connected to the compressor 7. For this, e.g., the construction of the first embodiment illustrated in FIG. 2 can be used.

In the second embodiment of FIG. 3, the compressors 7 are configured such that they are connected in series to each other and compress in multiple stages air which is supplied to the engine.

That is, some of the compressors 7, which are connected in series to each other to compress in multiple stages air which is supplied to the engine, are directly connected to a turbine 17 which generates rotational force, thus forming the construction of the conventional turbocharger. The rest of the compressors 7 are connected to and operated by the expander 5 which is operated by the working fluid of the waste heat recovery unit 1.

Meanwhile, in the third embodiment of FIG. 4, the compressors 7 are connected in parallel to each other to selectively compress air which is supplied to the engine.

In detail, for example, the compressors 7 are configured such that whether they are operated or not and the operational intensity thereof can be variously controlled depending on the operating area of the engine. Further, the compressors 7 are installed in parallel so that intake air that has been compressed in the compressors 7 is supplied together into a combustion chamber. In the turbo apparatus having this structure, some of the compressors 7 have the same structure as that of the typical turbocharger that uses exhaust gas of the engine, and the rest is connected to the expander 5, which is operated by the working fluid of the waste heat recovery unit 1. Thereby, the control mode of the turbo apparatus can be more diversified, and the engine can be more reliably supercharged.

As described above, in an exemplary embodiment of the present invention, energy recovered from a waste heat recovery system of a vehicle can be used to improve the operation of a turbo apparatus, thus reducing turbo lag which is caused in the conventional turbo apparatus, and enhancing the responsivity and acceleration performance of the turbo apparatus when the vehicle accelerates. Eventually, the present invention makes downsizing and downspeeding of the engine possible and ensures sufficient output power, thus markedly improving the fuel efficiency of the vehicle.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A turbo apparatus using a waste heat recovery system for a vehicle, comprising:
a waste heat recovery unit heating a working fluid by using waste heat of the vehicle; and
an expander provided in a turbocharger and fluid-connected to the waste heat recovery unit, wherein the expander generates a rotational force by using the working fluid supplied from the waste heat recovery unit thereto and transmits the rotational force to a turbo shaft.

2. The turbo apparatus as set forth in claim 1, further including a working fluid switch unit provided to switch a state of the working fluid of the waste heat recovery unit between a state in which the working fluid passes through the expander and a state in which the working fluid bypasses the expander.

3. The turbo apparatus as set forth in claim 2, wherein the working fluid switch unit includes:
an inlet valve provided on a path along which the working fluid is transmitted from the waste heat recovery unit to the expander;
an outlet valve provided on a path along which the working fluid that has passed through the expander returns to the waste heat recovery unit; and
a bypass pipe connecting the inlet valve to the outlet valve,
wherein the working fluid flows from the inlet valve to the outlet valve while bypassing the expander according to operation of the inlet valve and the outlet valve.

4. The turbo apparatus as set forth in claim 3, further including
a one-way clutch provided between the expander and the turbo shaft of the turbocharger so that the rotational force is transmitted only in a direction from the expander to the turbo shaft.

5. The turbo apparatus as set forth in claim 3, wherein the expander is disposed between a turbine and a compressor of the turbocharger.

6. A turbo apparatus using a waste heat recovery system for a vehicle, comprising:
a waste heat recovery unit heating a working fluid by using waste heat of the vehicle;
a plurality of compressors provided to compress intake air to be supplied to an engine; and
an expander fluidly-connected to the waste heat recovery unit to generate rotational force by using the working fluid supplied from the waste heat recovery unit and coupled to at least one of the compressors, wherein the expander operates the at least one of the compressors by using the rotational force.

7. The turbo apparatus as set forth in claim 6, wherein the expander transmits the rotational force generated by the working fluid of the waste heat recovery unit, to the at least one of the compressors through a rotating shaft connected thereto.

8. The turbo apparatus as set forth in claim 7, wherein the plurality of compressors are connected in series to each other to compress, in multiple stages, air to be supplied to the engine.

9. The turbo apparatus as set forth in claim 7, wherein the plurality of compressors are connected in parallel to each other to selectively compress air to be supplied to the engine.

10. The turbo apparatus as set forth in claim 9, wherein at least a turbine is fluidly-connected to the at least one of the compressors.

11. The turbo apparatus as set forth in claim 9, wherein at least a of the plurality of compressors is connected to a turbine.

12. The turbo apparatus as set forth in claim 6, wherein the working fluid switch unit includes:
an inlet valve provided on a path along which the working fluid is transmitted from the waste heat recovery unit to the expander;
an outlet valve provided on a path along which the working fluid that has passed through the expander returns to the waste heat recovery unit; and
a bypass pipe connecting the inlet valve to the outlet valve so that the working fluid flows from the inlet valve to the outlet valve while bypassing the expander according to operation of the inlet valve and the outlet valve.

13. The turbo apparatus as set forth in claim 6, further including
a one-way clutch provided between the expander and a turbo shaft of the turbocharger so that the rotational force is transmitted only in a direction from the expander to the turbo shaft.
